(19) United States
(12) Patent Application Publication
(10) Pub. No.: US 2022/0371631 A1
(43) Pub. Date: Nov. 24, 2022

(54) INTEGRATED MOBILITY SYSTEM

(71) Applicant: CRAIN MOBILITY S.R.L., Torino (IT)

(72) Inventors: Sara ARMOCIDA, Torino (IT); Gianvito LIONETTI, Milano (IT)

(21) Appl. No.: 17/767,002

(22) PCT Filed: Oct. 8, 2020
(86) PCT No.: PCT/IB2020/059450

§ 371 Date: Apr. 6, 2022

(30) Foreign Application Priority Data
Oct. 11, 2019 (IT) 102019000018554

(51) Int. Cl. B61D 47/00; B61D 3/18; B61C 17/06; B61D 27/00; B60L 50/60; B60N 2/14; B60N 2/06; H01M 50/204; H01M 50/249; H01M 50/512

(52) U.S. Cl. CPC B61D 47/005; B61D 3/187; B61C 17/06; B61D 27/0072; B60L 50/60; B60N 2/14; B60N 2/06; H01M 50/204; H01M 50/249; H01M 50/512; B61D 35/005

(57) ABSTRACT

An integrated mobility system includes at least one road module, at least one railway module adapted to contain a plurality of road modules therein, and a plurality of loading/unloading infrastructures arranged in a plurality of boarding and unboarding stations scattered over a territory to allow operations for boarding/unboarding the road modules from the railway module. The railway module can be a two-story high-speed railway module. The boarding/unboarding stations are equipped with the loading/unloading infrastructures arranged so that the operations for boarding/unboarding the road module with respect to the railway module are always possible regardless of the position occupied by the road module inside the railway module, and regardless of simultaneous boarding and unboarding of other road modules. The road module and the railway module are arranged to be automatically interconnected to each other in the condition in which the road module is received inside the railway module.

### FIELD OF THE INVENTION

The present invention relates to integrated mobility techniques.

The solution described herein responds to a demand for integrated mobility which combines long-distance mobility using the railway mode with short-to-medium-range mobility using the road mode.

### KNOWN PRIOR ART

Solutions for the transport of road modules on board other carriers, such as, for example, car carrier trailer, trains, ships, coaches etc. are known in the art.

For example, document WO 2010/060196 A1 discloses a solution for transporting a plurality of small road modules which may be transported all together by means of a larger carrier. In the solution described in this document, the largest carrier is a coach and the small road modules are single-seat vehicles. In the prior art, the solutions suggested use light, low-speed, and non-standard quadricycles to allow the loading of a suitable number of vehicles.

The known solutions focus on short-to-medium-range routes.

In the prior art, the interfaces between the road module and the carrier receiving it are limited to the connections made manually by means of pipe couplings and power sockets, to supply, respectively, air-conditioning and electricity to the auxiliary systems.

### SUMMARY OF THE INVENTION

The present invention relates to integrated mobility techniques.

The exclusive choice of the railway module as the main carrier for the present invention is due to a series of factors described below.

Only the railway mode allows to reach speeds which are higher than those allowed by the highway code (unlike road mobility) and always higher than those of the road module contained in the main carrier under a regulated traffic regime, with consequent reliable time scheduling. Such a factor is essential for the competitiveness of the mobility system with respect to other systems. The commercial speed of trains (city center-city center), nowadays for distances up to 800 km, is also higher than that of airplanes.

Only the railway mode allows to reach speeds which are higher than those allowed by the highway code, by virtue of the safety levels ensured by automatic controls. The automation introduced by train speed control systems in the 1960s with electromechanical technologies and in the 2000s with, for example, the ERTMS (European Rail Traffic Management System) digital system, ensures that any incorrect behavior or sudden illness of the driver does not lead to any consequences for the safety of passengers and goods.

Furthermore, the railway mode involves a significantly lower specific energy consumption with respect to main road carriers (for example, coaches) and airplanes.

Finally, the exclusive choice of the railway module also entails the possibility of creating dedicated loading and unloading stations with freedom to choose platform heights due to the absence of urban planning constraints which are conventional in the road mode. In the prior art, complex mechanical, electrical, and hydraulic lifting systems must be provided.

The technical problem that the solution described herein poses and solves is the impossibility for people and goods to move from a starting point to a destination point over the medium-long-range distance using two different modes of transport without any intermediate reloading or solution of continuity.

The system CM of the solution suggested herein exploits a “soft” intermodality between the two modes of transport (railway and road) which completely eliminates the so-called intermediate reloading, according to the transport jargon.

The term intermediate reloading means the situation whereby goods and passengers need to change their means of transport, even more than once, to get to the destination thereof.

For example, from the origin of the journey to the departure station, and then from the arrival station to the final destination. This limitation is very inconvenient, slow, and often expensive (it requires more means “by appointment”, i.e., it does not allow “door to door” transport).

Furthermore, intermediate reloading involves inefficiency, time consumption and “discomfort” for the travelling customer (or passenger) and the personal belongings thereof, having to switch from one mode of transport to another, getting off one vehicle and getting on another vehicle of the same or different type.

The solution described herein relates to an integrated mobility system comprising at least one road module, at least one railway module, adapted to contain a plurality of road modules therein, and a plurality of loading and unloading infrastructures arranged in a plurality of boarding and unboarding stations scattered over the territory to allow the operations for boarding and unboarding the road modules from the railway module.

The railway module is a two-story high-speed railway module and the boarding and unboarding stations are equipped with the loading and unloading infrastructures arranged so that the operations for boarding and unboarding the road module with respect to the railway module are always possible regardless of the position occupied by the road module inside the railway module and regardless of the simultaneous boarding and unboarding of other road modules. Furthermore, the road module and the railway module are arranged to be automatically interconnected to each other in the condition in which the road module is received inside the railway module.

In various embodiments, the road module comprises rechargeable batteries and the railway module includes a traction system comprising rechargeable batteries. In this case, the physical and functional interconnection between the road module and the railway one allows the connection of the rechargeable batteries of the road module to the rechargeable batteries of the railway module.

In different embodiments, the physical and functional interconnection between the road module and the railway one allows the connection of the air-conditioning system of the road module to the air-conditioning system of the railway module, as well as the mechanical connection and the fastening of the road module to the railway module.

In particular, the railway module is equipped with movable systems adapted to cooperate with the loading and unloading infrastructures to perform the operations for boarding and unboarding the road module from the railway module.

Preferably, the movement of movable systems for loading and unloading the road modules with respect to the railway modules is performed with manual systems, or with hydraulic systems or electrical systems, which involve the use of slides, rolling bearings or magnetic bearings.

In various embodiments, the movable systems comprise doors for closing and opening the compartments of the railway module and sliding platforms to allow the operations for boarding and unboarding the road module.

In various alternative embodiments, the movable systems are selected from ejecting and upward sliding closing and opening doors, closing and opening doors made in an appropriate number of segments of the retractable roller shutter type which will roll up until concealing in the ceiling of the compartment of the railway module, closing and opening winged doors hinged on the upper side, and closing and opening winged doors hinged on the lower side.

In particular, the loading and unloading infrastructures arranged in the boarding and unboarding stations comprise the construction of tracks equipped with platforms for the access to the two boarding levels of the two-story railway module, and the loading and unloading infrastructures comprise at least one access platform to the lower floor and at least one access platform to the upper floor.

In addition, the loading and unloading infrastructures comprise two access ramps to the lower platform and to the upper platform.

In some embodiments, the access platform to the upper floor comprises a movable portion, movable between a lowered position and a raised position, to allow, when not in use, the opening of the doors of the lower floor of the railway module.

Preferably, the road module is designed as a standard car with a propulsion system chosen from: conventional, hybrid, plug-in hybrid, full electric battery powered, or fuel cell powered. In particular, in the road modules with plug-in hybrid or electric battery powered propulsion system, the connection, which may be wireless or by means of the connectors of the rechargeable batteries of the road module, to the rechargeable batteries of the railway module occurs in parallel.

The system according to the present invention further includes at least one railway module equipped with a compartment for road modules adapted to transport people with reduced mobility.

Furthermore, railway modules are provided in which the bogies are shared with the adjacent railway modules.

In particular, the road mode takes on a housing function in the railway mode and becomes a true car in the road mode.

In preferred embodiments, the road module is equipped with sliding doors to optimize the space when it is inside the railway module.

In different embodiments, the road module is equipped with a “concealable” steering wheel.

Preferably, the road module is equipped with manual or automatic systems for rotating the front seats to allow the occupants to travel vis-a-vis with the rear seat occupants in the railway mode, while maintaining a conventional driving position in the road mode.

In various embodiments, the road module is equipped with mechanical slides for sliding the front seats which are controlled manually or in an automatic and synchronized manner.

In preferred embodiments, the road module is equipped with broadband wireless data connection and VOIP voice connection systems, satellite navigation, multimedia entertainment, travel information and ticketing.

Furthermore, in alternative embodiments, the railway module provides for the boarding of the road modules at two different levels on the same side or on opposite sides.

Lastly, the railway module comprises sensors and actuators connected in fiber or wireless network.

It is of course possible to provide a train consisting of a plurality of railway modules. In the loading and unloading infrastructures, stabling tracks are provided, comprising sets of platforms to obtain stabling tracks of a double length with respect to the length of the train consisting of a plurality of railway modules and in which a first portion of the set of platforms includes high platforms facing the right side of the train and low platforms facing the left side of the train, and in which a second portion of the set of platforms includes high platforms facing the left side of the train and low platforms facing the right side of the train.

In alternative embodiments, the loading and unloading infrastructures comprise a plurality of stabling tracks of a length equal to that of a train, a part of which is equipped with low platforms on the right and high platforms on the left and the remaining with low platforms on the left and high platforms on the right.

Furthermore, the loading and unloading infrastructures comprise an automatic driving system for routing the train and for placing it on the correct stabling track.

Of course, the present invention also relates to a corresponding method for managing an integrated mobility system.

### BRIEF DESCRIPTION OF THE DRAWINGS

Further features and advantages of the invention will become apparent from the following description provided by way of example and not by way of limitation, with the aid of the figures shown in the accompanying drawings, in which:

FIG. 1 shows some examples of medium and long-distance routes which may be traveled by the system in accordance with the invention,

FIGS. 2, 3, 4, and 5 show some steps of the operations for loading a road module on a railway module,

FIG. 6 shows the connection of the batteries between the road module and the railway module,

FIG. 7 shows the connection of the air conditioning system between the road module and the railway module,

FIG. 8 shows an example of a train consisting of three railway modules,

FIGS. 9 and 10 show examples of loading and unloading infrastructures, in particular, for single-story or two-story trains,

FIGS. 11, 12 and 13 show sectional side and plan views, respectively, of the first and of the second floor of a two-story railway module,

FIG. 14 shows the usable spaces inside the railway module after the road module has been loaded therein,

FIGS. 15, 16 and 17 show the steps for rotating the front seats of a road module to obtain the compartment configuration, and

FIGS. 18, 19, 20 and 21 show the infrastructures for loading the road modules on the two floors of the railway module.

The parts according to the present description have been depicted in the drawings, where appropriate, with conventional symbols, showing only those specific details which are pertinent to the understanding of the embodiments of the present invention, so as not to highlight details, which will be immediately apparent to those skilled in the art, with reference to the description provided below.

### DETAILED DESCRIPTION OF THE INVENTION

The solution described herein is based on the exclusive choice of the railway mode as a carrier system.

In the prior art, for example, in document WO 2010/060196, the carrier system is based on a road vehicle.

The choice to use the railway mode as a carrier system is due to a series of factors described below.

The railway mode allows to reach absolute land speeds which are higher than those allowed by the highway code and also ensures a regulated traffic regime, with consequent reliable time scheduling.

The speed factor is essential for the competitiveness of the integrated mobility system of the invention with respect to other similar systems designed or contemplated in the prior art. In particular, the commercial speed of trains (city center-city center), nowadays for distances up to 800 km, is also higher than that of airplanes.

The railway mode allows to reach speeds which are higher than those allowed by the highway code, by virtue of the safety levels ensured by automatic controls.

Furthermore, the railway mode involves a significantly lower specific energy consumption with respect to main road carriers (for example, coaches) or airplanes. The present invention is based on the use of two-story trains; the maximum height of a coach is in fact 4 m, while the one allowed by the standard European railway network is 4.6 m, which allows a free height for the passage of people of at least 1.90 m both on the lower floor and the upper floor.

The exclusive choice of the railway module also entails the possibility of creating dedicated loading and unloading stations with freedom to choose platform heights due to the absence of urban planning constraints which are conventional in the road mode.

In the prior art, which is focused on a road carrier system, complex mechanical, electrical, and hydraulic lifting systems were instead provided to overcome such an issue.

For the sections in which the railway infrastructure is uncapable of satisfying the extensiveness required, the road mode integrates any initial, intermediate, and final segments of the journey, thus offering the possibility of seamlessly joining the railway sections.

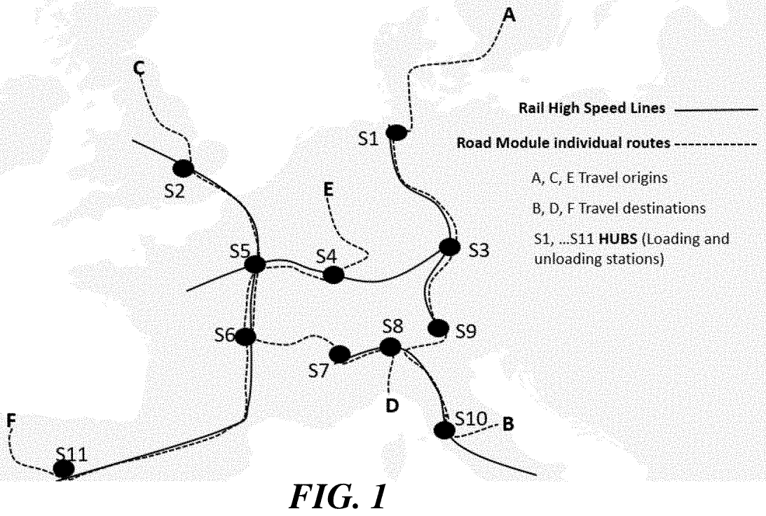

With reference to FIG. 1, some examples of medium and long distance routes are shown in which the hubs, or the boarding and unboarding stations (places dedicated to the interchange between the road mode and the railway mode), are located in strategic points, served by or connected to the railway network (high-speed, in the preferred embodiment), while the road segments are completely free.

In FIG. 1, the sections on the high-speed railway lines are indicated with a solid line, while the sections on the road module are indicated with a dashed line.

Points A, C, E are the origins of the journeys, while points B, D, F are the destinations of the journeys.

References S1 . . . S11 indicate, in the Figures, the HUBS, i.e., the railway module boarding and unboarding stations.

Table 1 diagrammatically shows three examples of possible road-railway itineraries with reference to FIG. 1, with different uses of the two modes on different segments.

TABLE 1

| | Itinerary | | Itinerary | | Itinerary | Mode |
|---|---|---|---|---|---|---|
| | AB | Mode | CD | Mode | EF | |
| Segments | A-S1 | Road | C-S2 | Road | E-S4 | Road |
| | S1-S3-S9 | Railway | S2-S5 | Railway | S4-S5 | Railway |
| | S9-S8 | Road | S5-S6 | Railway | S5-S6 | Railway |
| | S8-S10 | Railway | S6-S7 | Road | S6-S11 | Railway |
| | S10-B | Road | S7-S8 | Railway | S11-F | Road |
| | | | S8-D | Road | | |

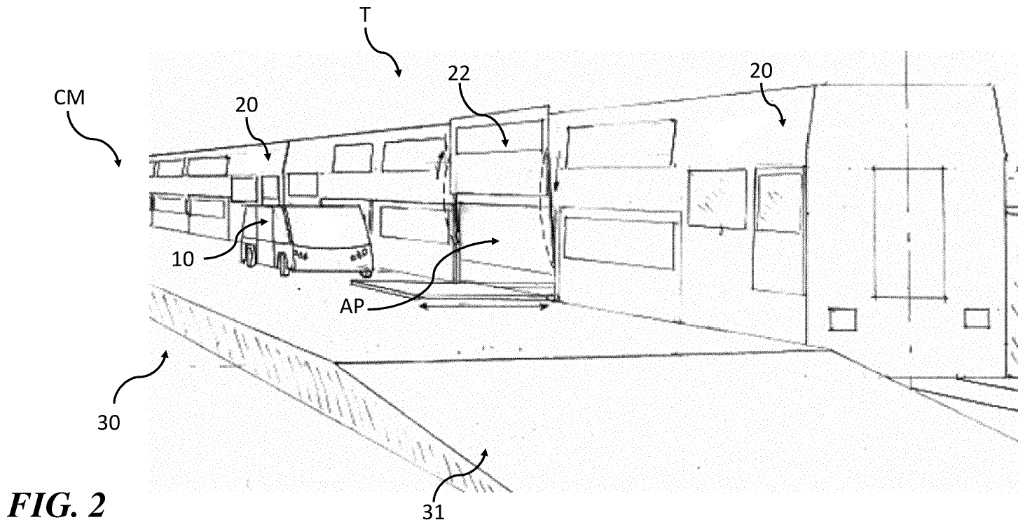

The fundamental tangible components (hardware) of the system CM described herein are shown in FIG. 2 and consist of the road module 10 and one or more railway modules 20 and an infrastructure 30.

The system CM described herein is totally different from the intermodal car-train systems referred to in the prior art or present on the market, such as, for example, the trains “Autostrada Ferroviaria Alpina”, “Auto al seguito” of FS, “Autozug” of DB and Transmanche Link.

These systems may sometimes involve operations for loading and unloading vehicles, regardless of the status of occupancy of the train spaces (for example, as described in documents FR2810612A1 and U.S. Pat. No. 3,285,194A), as well as contemplate the use of two-story car carrier trailers.

However, the following differences or novelties with respect to the prior art may be noticed in the present invention.

The road module 10 and the railway one 20 are modules dedicated to the combined use in the system CM described herein and are designed as a single inseparable technological and functional system.

The system CM described herein shifts the focus to the concept of Car Sharing and Car Pooling, since the road module 10, in the preferred embodiment, is designed to be rented in a plurality of locations and without time constraints (medium or long-term rental).

The system CM in accordance with the invention provides for a physical and functional integration between the road module 10 and the railway module 20 with a continuous interaction between the technological systems of the two modules (in particular, the traction one).

The system CM described herein allows the movement from a plurality of starting points A, C, E to a plurality of destination points B, D, F, without binding the users to a single predetermined route which is the same for everyone. It also allows the transition from the railway mode to the road one in all intermediate stations S1 . . . S11 and regardless of the loading position of the road module 10 inside the railway module 20.

The integration between the road module 10 and the railway module 20 will now be described.

The close integration and physical and functional interconnection between the road module 10 and the railway module 20 form one of the essential elements of the system CM described herein.

Below is a description of the main distinctive features of the solution considered herein.

The intermodal solution provided consists in considering the railway module 20 and the road one 10 as two modules responding to the same passenger and goods mobility function, using the existing railway (mainly, high-speed lines and freight terminals as interchange points) and road infrastructures.

The road module 10 is moved to be positioned inside the railway module 20. The railway module 20 does not require the conventional interior furnishings of conventional railway vehicles for placing passengers.

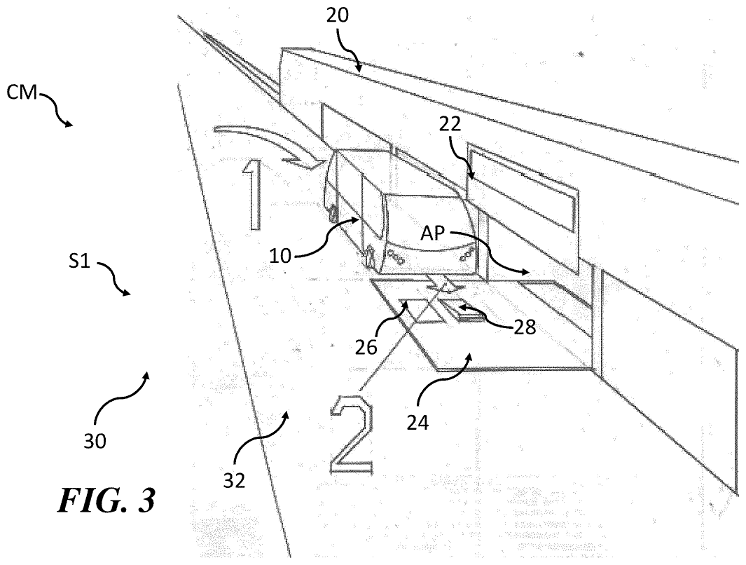

The passengers and the luggage thereof will not have to unboard or be unloaded from the road module 10 to board the railway module 20 as shown in the sequence in FIGS. 3, 4 and 5.

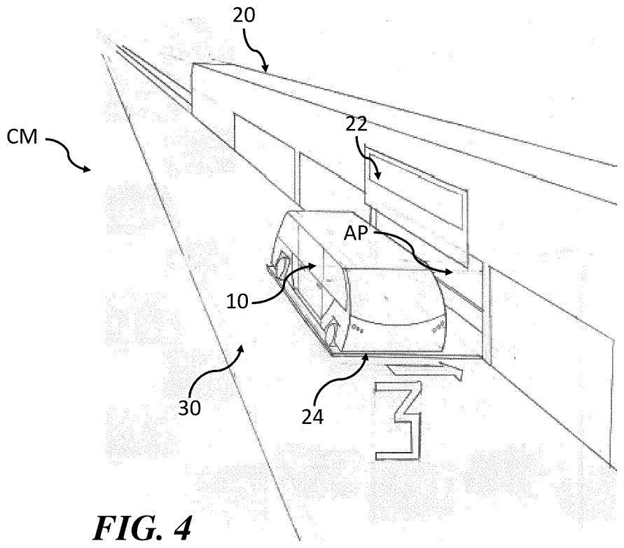

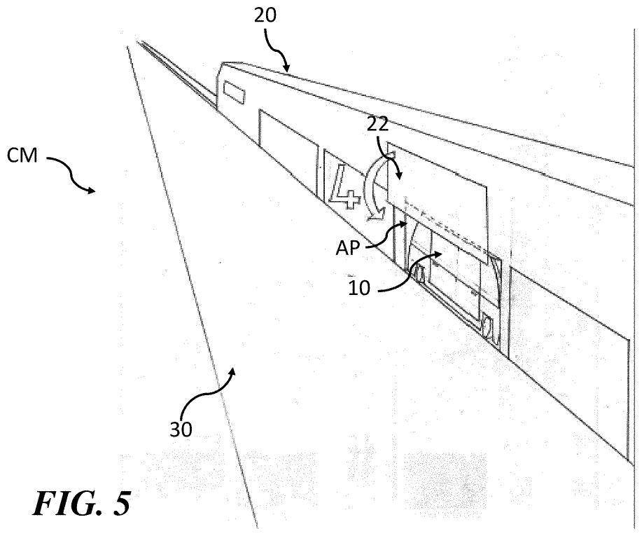

In particular, FIG. 3 shows the arrival of a road module 10 at an interchange station S1, FIG. 4 shows the operations for loading the road module 10 on the railway module 20, and FIG. 5 shows the road module 10 completely loaded on the railway module 20, ready to resume the journey.

As shown in FIGS. 3-5, the sequence of loading operations involves a first step 1 of arrival of the road module 10 on a loading and unloading infrastructure 30 near the railway module 20, a second step 2 of boarding the road module 10 onto a loading/unloading platform 24, a step 3 of positioning the road module 10 inside the railway module 20 by means of the loading/unloading platform 24 (FIG. 3 shows the translation of the loading/unloading platform 24 which allows to load the road module 10 inside the railway module 20), and finally, in a step 4, the closing of the railway module 20, for example by means of a door 22 connected to the railway module 20.

The operations for boarding and unboarding the road module 10 onto/from the compartment of the railway module 20 are always possible.

In particular, the operations for boarding and unboarding the road module 10 are possible regardless of the position of the compartment occupied inside the railway module 20.

In addition, the operations for boarding and unboarding the road module 10 are possible regardless of the boarding and unboarding of other road modules 10.

Of course, the operations for boarding and unboarding the road module 10 are possible at any boarding and unboarding station S1 . . . S11.

Passengers do not make any check-in, boarding and unboarding transition from the road mode to the railway one and vice versa, except inside the road mode 10. Passenger luggage does not undergo any delivery and collection transition, but it is transferred from the road mode to the railway one and vice versa, inside the road module 10.

Security checks with dedicated scanning systems take place at the entrance of the road module 10 in the appropriate stations S1 . . . S11 (loading and unloading areas). During such checks, the passengers do not unboard the road module 10.

The road module 10 transits from the roadway to the railway module 20 with a simple maneuver for the positioning on the loading and unloading infrastructure 30. Such a loading and unloading infrastructure 30 includes movable loading and unloading systems, such as, for example, the extractable platform 24. In particular, the movable loading and unloading systems may be connected to the railway module 20 or be an integral part of the railway module 20, and may be designed in a plurality of versions, such as, for example, an extractable platform or a tilting platform, or include elevators.

Such movable loading and unloading systems become an integral part of the loading and unloading infrastructure 30 which acts as an interface between the road module 10 and the railway module 20. For example, all the interfaces between the road module 10 and the railway module 20, which carry out the functions described below, may be included in the loading platform 24.

The connection 26 of the batteries of the road module 10 in parallel with the batteries of the railway module 20, and the connection 28 of the air-conditioning system of the road module 10 with the one of the railway module 20.

It is also possible to include the wireless connection of the multimedia network of the road module 10 to the multimedia network of the railway module 20, and the mechanical connection and fastening of the road module 10 to the railway module 20.

The movement of the extractable platforms 24, which are part of the movable loading and unloading systems, and the movement of the closing doors 22 of the railway module 20 is performed with manual, hydraulic or electric systems.

The system CM involves the use of slides, rolling bearings or magnetic bearings for opening and closing the platforms 24 and the doors 22. Such devices allow both the automatic and the manual handling of the opening and closing operations by specialized personnel.

Special slides may be provided, which allow to overcome the difference in height between the platform 32 and the extractable platform 24.

Such a difference in height may be generated by the thickness of the platform 24 itself, or by an appropriate distance between the height of the platform 24 when exiting the railway module 20 and the platform 32.

The above slides may also form the mechanical locking of the road module 10 on the extractable platform 24.

The batteries 15 of the road modules 10 are connected in parallel to the batteries 25 of the railway module 20, forming an integrated storage system. The battery chargers of the railway module 20 keep the entire integrated storage system charged.

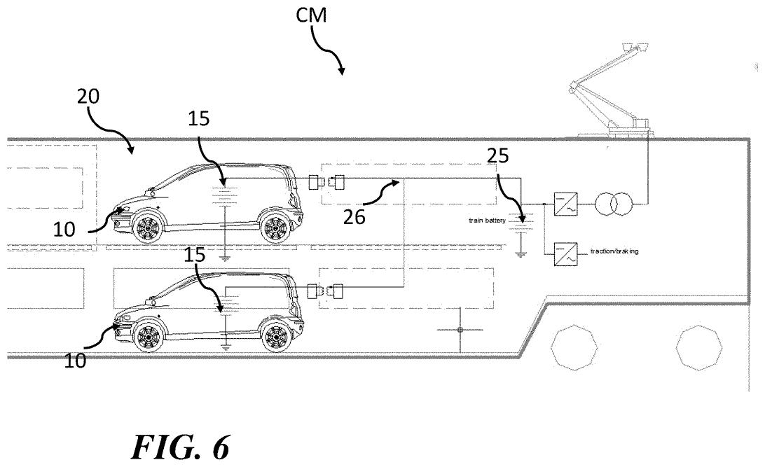

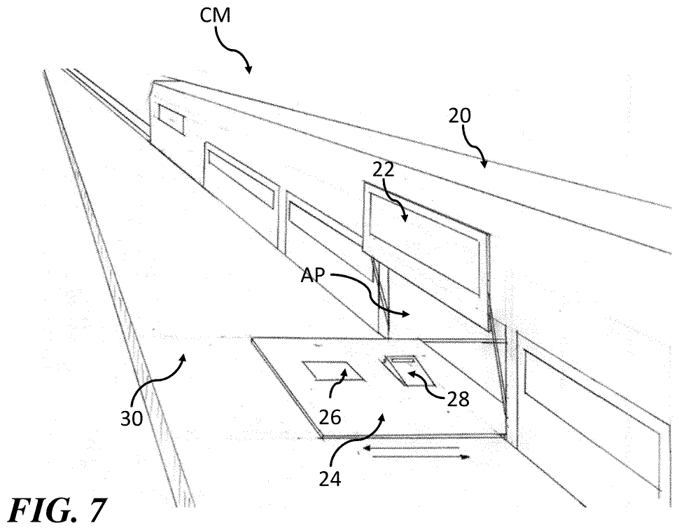

The connection 26 which parallels the battery of the road module 10 with the batteries of the railway module 20 may be a wireless induction, as shown in FIG. 6. FIG. 6 shows the functional wiring diagram, while the physical positioning of the connection is shown in FIG. 7.

The connection 28 of the air-conditioning system of the road module 10 to the air-conditioning system of the railway module 20 may occur by means of special bellows which are located in the platforms 24 and also engage the specific inlets of the air conveyors of the road module 10 by directly introducing air-conditioning from the centralized system of the railway module 20 into the passenger compartment of the road module 10, as shown in FIG. 7. In particular, reference 26 indicates the induction coil or the connector for the parallel connection to the batteries of the railway module 20, while reference 28 indicates the bellows connection to the air-conditioning system of the railway module 20.

In the prior art, the interfaces between the car and the carrier receiving it are limited to the connections made manually by means of pipe couplings and power sockets, to supply, respectively, air-conditioning and electricity to the auxiliary systems; there is no automatic system which obtains the physical connection of the aforesaid functions.

In the system CM described herein such functions are implemented automatically. Furthermore, the solution suggested herein allows to introduce the following benefits, which form an integral part of the object of the invention.

The automatic connection (wireless or by means of connectors) of the batteries 15 of the road module 10 in parallel with the batteries 25 of the railway module 20 is conceptually shown in FIG. 6. Such a function is very important, since it allows the batteries 15 to be charged while the road module 10 travels on the railway module 20, thus obviating the issue of low autonomy and forced stops at the charging points for electric road vehicles 10.

Another benefit introduced is the wireless connection of the road module 10 to the multimedia network of the railway module 20.

In the solution described herein, the railway module 20 is the main carrier.

The solution suggested involves the use of a railway module 20 adapted for the circulation at the maximum speeds allowed on the European High-Speed network. The main features of the railway module 20 required to adapt to the system CM are described below.

The railway module 20 has a maximum speed equal to the maximum speed allowed on the European High-Speed network. Such a requirement is not binding for the functioning of the module, but is essential for the admissibility on the European high-speed network and for the competitiveness of the system described herein compared to the other mobility models available.

More railway modules 20 (which nowadays correspond to the concepts of wagons or carriages) may be coupled thus forming a “train” or “train consist” T. The number of wagons 20 is variable, so as to meet the needs of a flexible capacity demand.

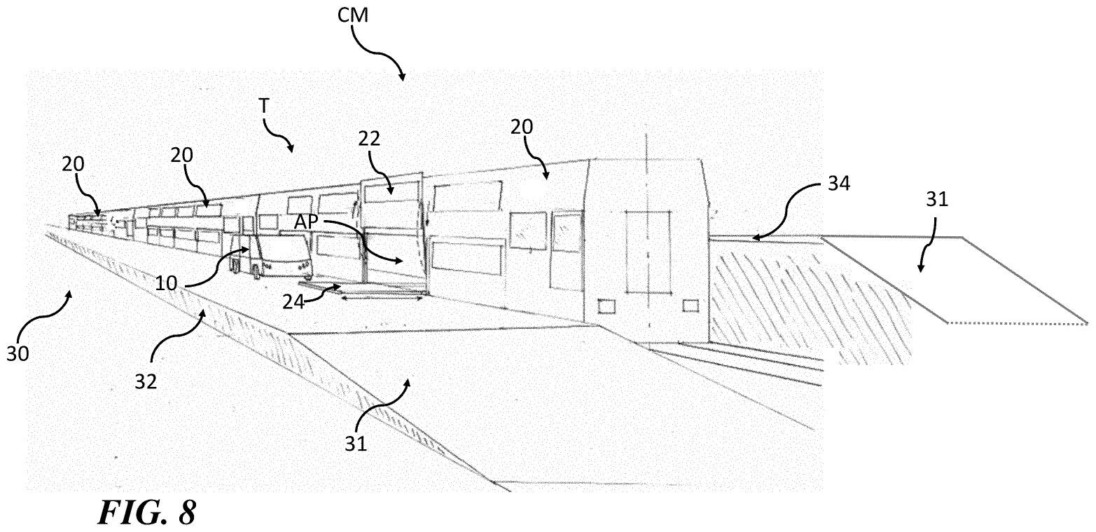

For example, FIG. 8 shows a train T consisting of three railway modules 20.

The closing and opening doors 22 of the compartments of the railway module 20 may be in a plurality of variants.

Some of the possible variants are listed below.

Closing and opening doors 22:
ejecting and upward sliding;
made in an appropriate number of segments which will roll up until concealing in the ceiling of the compartment of the retractable roller shutter type,
winged, hinged on the upper side, and
winged, hinged on the lower side: in this case, they may form a slide for the lateral translation of the road modules 10 in the version with 90° steering wheels or small retractable wheels, as described in more detail in the rest of the description.

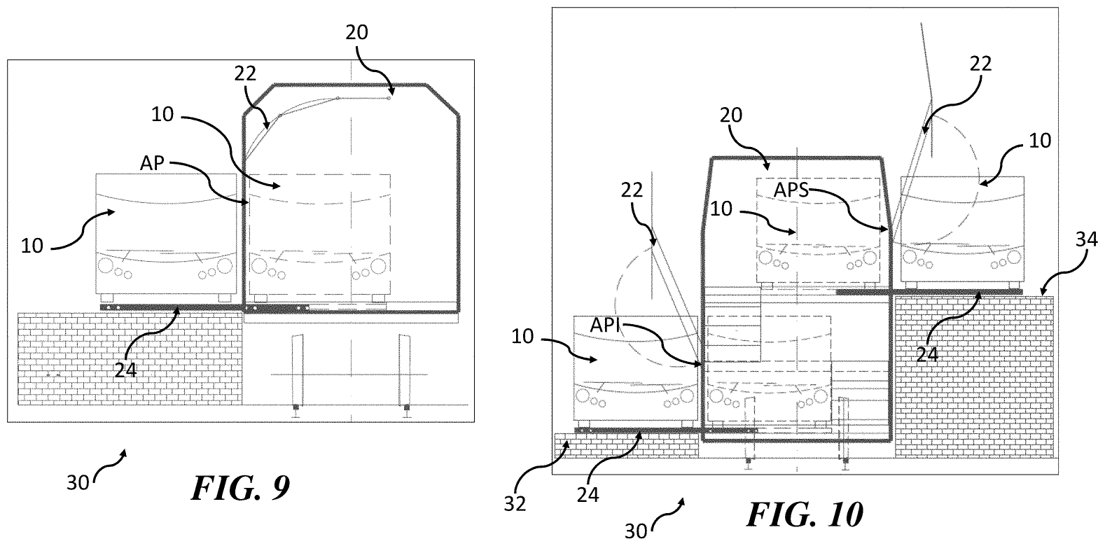

The railway module 20 may be a single-story module or, as a preferred embodiment, a two-story one, so as to combine the flexibility of use on lines with reduced profiles and maximize the capacity offered on lines with profiles which allow the use of the two-story solution, as shown in FIGS. 9 and 10.

In particular, FIG. 9 shows the use of a concealing roll-up door 22 while FIG. 10 shows the use of roto-translating doors 22.

The railway module 20 contains from one to several compartments for accommodating the road modules 10 on one or two floors.

The railway module 20 may be equipped with network connected monitoring systems (IoT).

The traction systems of the railway module 20 may use the energy stored in the integrated storage system for running without power from the contact line even for significant distances.

The railway module 20 will be equipped with one or more toilet facilities WC. It may also be equipped with adequate relax/food areas. The train T may include standard railway modules, such as, for example, dining cars or carriages responding to various functions.

At least two railway modules 20 per train T will be equipped with a compartment for road modules adapted to transport people with reduced mobility. The compartment will be located near a toilet facility WCH equipped for people with reduced mobility (PRM) in addition to any standard toilet facilities WC.

The railway module 20 may or may not be equipped with an own traction system. Special railway modules may be provided, only equipped with traction systems and electrical auxiliary services (locomotives).

The railway module 20 may be equipped with two own bogies or share them with the adjacent railway modules 20.

With respect to the prior art, the system CM described herein uses, in the preferred embodiment thereof, a two-story railway module 20, consequently obtaining the solution of the tracks equipped with platforms 30 for the access to the two boarding levels.

Such a solution allows to accommodate an extremely higher number of passengers (in the examples, a total of 48) with respect to what described in similar previous solutions (maximum 20).

FIG. 11 shows the load capacity of the railway module 20 in the preferred embodiment thereof, accommodating eight road modules 10 with six seats each and having the main dimensions of 4 m in length, 1.9 m in width and 1.7 m in height.

FIG. 12 shows the lower floor of the railway module 20 and the two portions of the intermediate height floor in which all the customer services and the technical compartments for on-board equipment and services may be located.

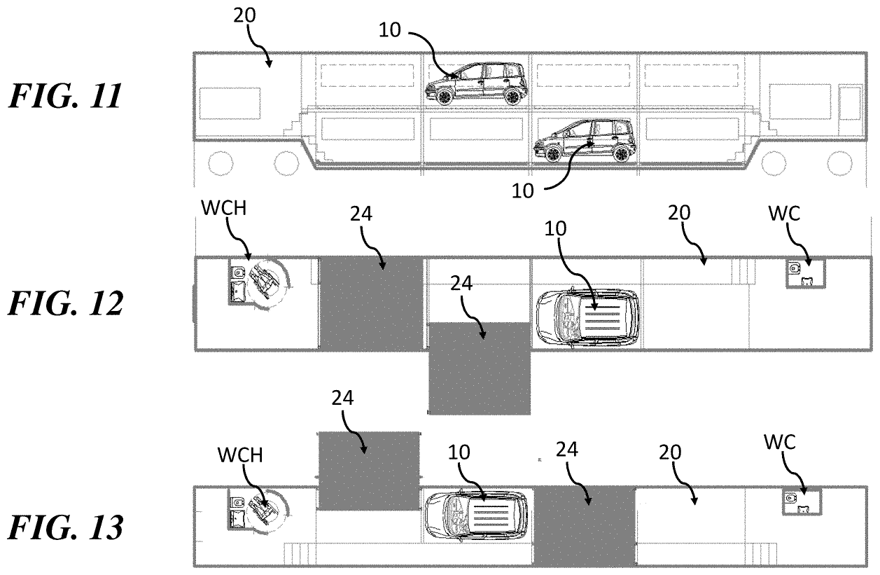

FIG. 13 shows the upper floor of the railway module, and the two areas on the intermediate floor are still visible.

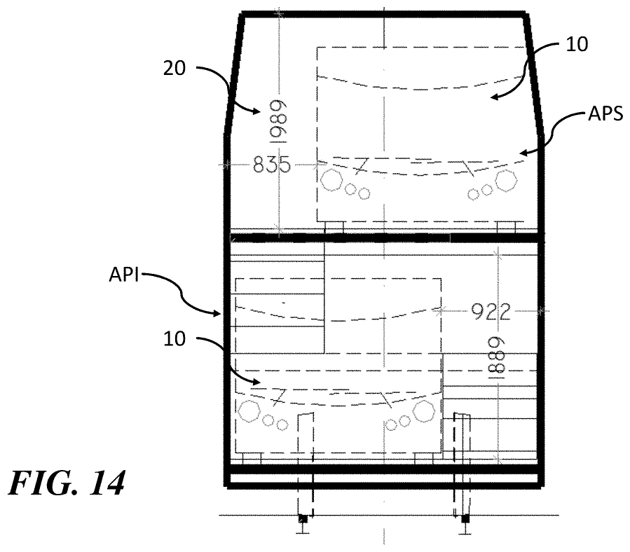

In the prior art there are no solutions allowing passengers to unboard the road module 10 and move freely inside the railway module 20 in spaces with a useful height of 1.9 m and corridors with a width of at least 0.83 m as shown in FIG. 14. Such spaces allow the passage of the wheelchairs for the disabled and the use of toilets.

The road module 10 or the housing module will now be described in detail.

Despite having functions dedicated to the use within the mobility system CM of the patent, the road module 10 is designed as a standard car with size and features which comply with worldwide homologation. Such features allow it to be driven by any user provided with a driving license (type B license) for even relatively long journeys depending on the needs.

The vehicle representing the road module 10, therefore, at the maximum speeds allowed by the highway code, does not have stability issues; in the prior art, similar solutions are found, which, however, use light, non-standard quadricycles at low speed, precisely to allow the loading of an adequate number of vehicles, still insufficient to ensure the competitiveness which the system CM described herein offers.

Such an inefficiency is solved in the present invention by means of the configuration of the two-story railway module 20. The road modules 10 are designed for medium-to-long term rentals and may be collected at any time and returned to any collection point or station (hub) S1 . . . S11. Furthermore, the road modules 10 may also be purchased by users, for example business users, who make frequent trips for work. The road module 10 is the true passenger transport module which takes on a housing function in the railway mode (compartment) and becomes a true car in the road mode.

The road module 10 may have the following features.

The road module 10 may be equipped with sliding doors to optimize the space when it is inside the railway module 20.

The road module 10 may be equipped with a “concealable” steering wheel (for example, retractable); the steering wheel retracts and automatically locks when the road module 10 passes through the entrance gate of hub S1 . . . S11. From that moment the road vehicle 10 is controlled remotely (by the infrastructure 30), the “compartment” configuration is enabled, and the driver may engage in activities other than driving.

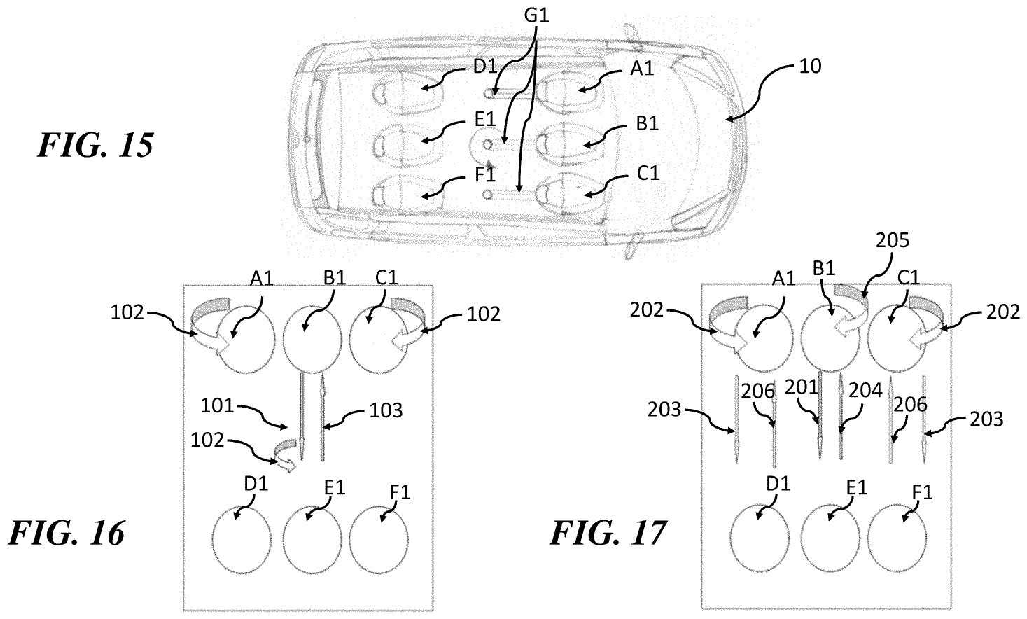

The road module 10 may be equipped with systems for rotating the front seats A1, B1 and C1 to allow the occupants to travel vis-a-vis with the rear seat occupants D1, E1 and F1 in the railway mode, while maintaining a conventional driving position in the road mode, as shown in FIG. 15.

In this regard, the present invention describes two different options for rotating the front seats A1, B1, and C1.

The first option shown in FIG. 16 allows to minimize the number of movements required to achieve “compartment” configuration. In particular, in a step 101, the front center seat B1 is moved back as indicated by the arrow, in a step 102, the three front seats A1, B1, and C1 are rotated by 180°, and in a step 103, the front seat B1 it is translated to be brought back in line with the seats A1 and C1.

The second option shown in FIG. 17 allows, while increasing the number of movements, to ensure a greater level of ergonomics, since the rotation of the seats always occurs away from the passengers positioned on the rear seats. In this case, in a step 201, the front seat B1 is made to slide towards the row of rear seats, in a step 202, the seats A1 and C1 are rotated by 180°, in a step 203, the seats A1 and C1 are made to slide towards the row of rear seats, in a step 204, the front seat B1 is brought back to the advanced position, and in a step 205, it is rotated by 180°, and finally, in a step 206, the front seats A1 and C1 are translated to return to the position in line with seat B1. The rotations of the front seats A1, B1 and C1 take place in both options by means of special mechanical slides indicated with the reference G1 in FIG. 15.

The movements of the seats may be handled manually or may be automatic and synchronized.

Furthermore, the road module 10 may be available in at least two different interior configurations, according to the needs of the users and corresponding at least to the different classes, Economy and Business.

Both configurations will also be available for users with reduced mobility.

By virtue of the planning of the requests of the road modules 10 in the various class set-ups, by means of the application, and of the modularity allowed by the system CM described herein, the management of the spaces will always be optimized, thus avoiding the waste deriving from the non-use of higher class spaces typical of the conventional railway mode and the airplane mode.

With regard to the propulsion system, all the existing versions are possible (conventional, hybrid, plug-in hybrid, full electric battery powered or fuel cell powered), however, the preferred embodiments of the invention are the plug-in hybrid and the electric battery powered (PHEV and BEV) so as to allow the connection of the batteries of the road module 10 in parallel with the batteries of the railway module 20.

The road module 10 may be equipped with appropriate physical devices to interface with the air-conditioning system of the railway module 20.

The road module 10 may be equipped with appropriate physical devices for the locking inside the railway module 20.

The road module 10 may be equipped with appropriate physical or intangible devices (wireless induction) to interface with the power system of the railway module 20 for sharing the energy storage.

The road module 10 may be equipped with a variable number of wheels.

The road module 10 may be equipped with steering systems for all the main wheels up to 90°, or with retractable small auxiliary wheels oriented at 90° with auxiliary motors for boarding on the railway module 20 by translating laterally as an alternative to using the extractable platform 24.

The road module 10 may be equipped with broadband wireless data connection systems and with systems for the VOIP voice connection to the train staff, satellite navigation, multimedia entertainment, travel information and ticketing, so as not to ever have to stop the vehicle for any operation of control, boarding, unboarding. etc. The road module 10 may be equipped with automatic systems for releasing the fuel tank (petrol, diesel, hydrogen) and the safe stowage of the fuel.

The road module 10 may be equipped with a system for completely releasing the chassis (powertrain, tanks, batteries, suspensions, and wheels) for exclusively boarding the housing component.

The road module 10 may be equipped with network connected monitoring systems (IoT).

The road module 10 may be equipped with a driving system remotely controlled within the station areas S1 . . . S11 and for the precise positioning on the extractable boarding platform 24.

The features of the infrastructural component 30 are now described.

The infrastructural component 30 of the system consists of tangible and intangible elements.

The tangible infrastructural component HW supporting the system CM consists of hubs S1 . . . S11 or dedicated interchange points between road and rail modes.

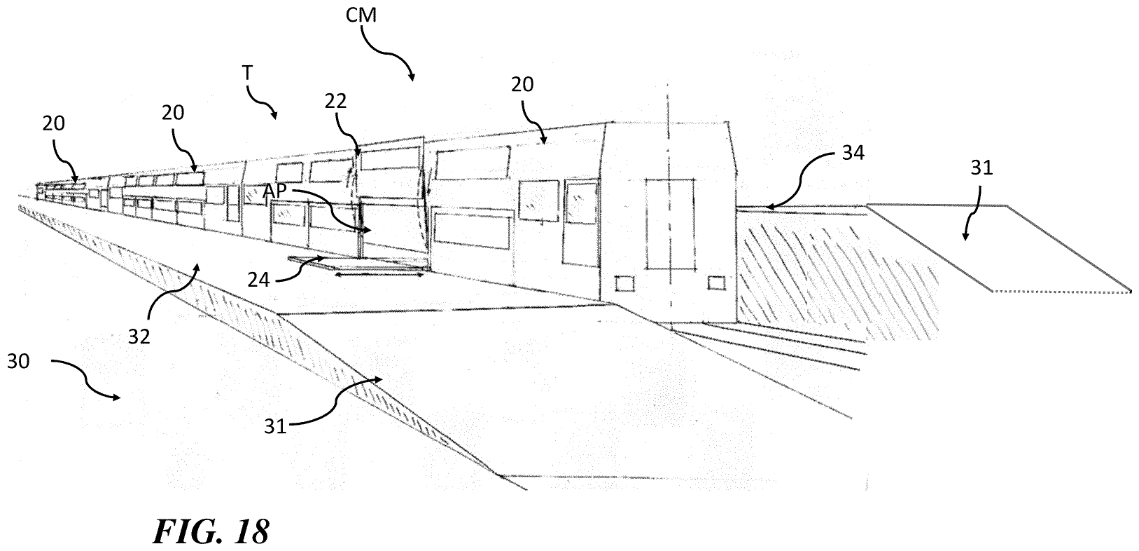

Such stations S1 . . . S11, as shown in FIG. 18, include tracks simply equipped with platforms 32 and 34 in concrete or other construction materials for accessing the boarding level of the road modules 10 on the railway modules 20.

In particular, the lower floor access platform is indicated by reference numeral 32, the upper floor access platform is indicated by reference numeral 34 and the access ramps to the lower platform 32 and to the upper platform 34 are indicated by reference numeral 31.

The stations S1 . . . S11 include the gates for the recognition and control of the road modules 10 with automatic reading of the destination and of a whole further set of information necessary for the management of the boarding and unboarding of the modules themselves as well as of the ticketing.

The stations S1 . . . S11 comprise the gates for controlling/scanning hazardous or non-permitted materials.

The railway modules 20, in the preferred embodiment, may be two-story vehicles which board the road modules 10 at two different levels (lower platform 32 and upper platform 34).

The two-story railway modules 20, for structural reasons, may have the openings AP, API and APS of the compartments for accommodating the road modules 10 of the lower floor API on one side (for example, on the right side) of the railway module 20 itself, and on the opposite side (for example, on the left side), for the upper floor APS, as shown for example in FIG. 10. Of course, it is possible to provide railway modules 20 with different arrangements.

The train consists of railway modules 20 may therefore be asymmetrical and oriented and appear on the stabling tracks of the hub S1 . . . S11 for loading and unloading with the appropriate openings API of the lower compartments both on the right and on the left and, mutually, with those of the upper floor compartments APS both on the left and on the right.

The configurations of the platforms in the stations S1 . . . S11 may therefore be those described below.

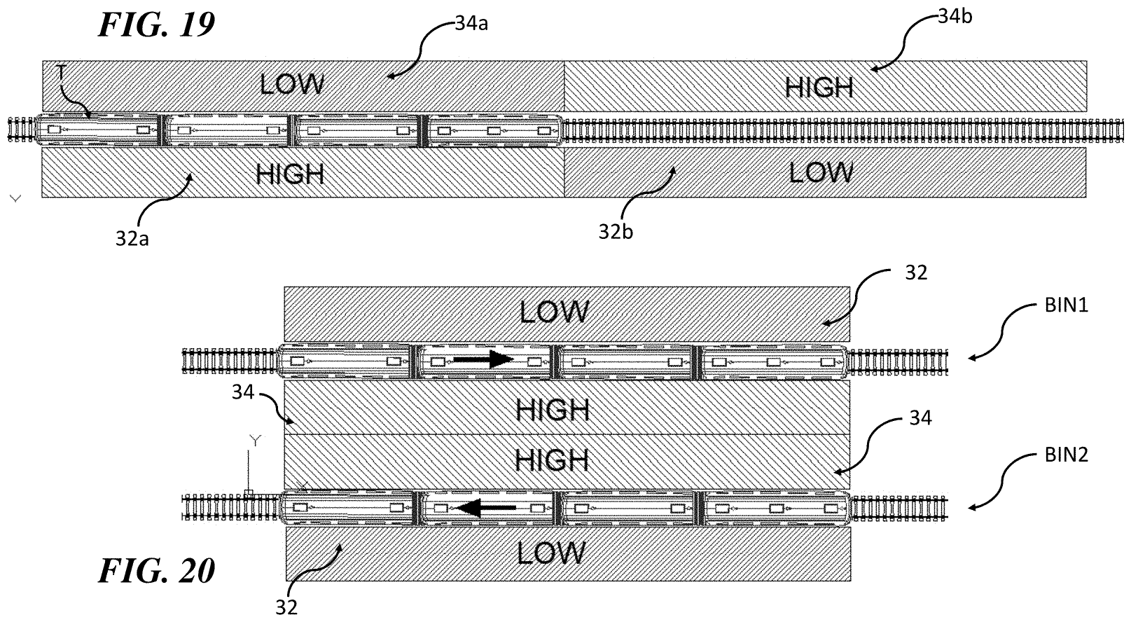

As shown in FIG. 19, it is possible to provide stabling tracks comprising the platforms 32a, 34a and introducing platforms 32b and 34b to obtain stabling tracks of a double length with respect to the length of the train or train consist T. In particular, it is possible to have platforms 32, for half the length of the track, which are high 32a on the right side of the railway module 20 and low 34a on the left side of the railway module 20, and for the other half, high 34b on the left side of the railway module 20 and low 32b on the right side of the railway module 20. The train consist T then proceeds to be positioned in the first “a” or in the second “b” half of the length of the track, according to the orientation of the railway modules 20. Special sensors of the platform 32 and 34 and the automatic driving system ensure the correct stabling point of the train consist T.

With reference to FIG. 20, it is possible to provide for a plurality of stabling tracks BIN1 and BIN2 of a length equal to that of a train consist T, a part of which is equipped with low platforms 32 on the right and high platforms 34 on the left and the remaining with low platforms 32 on the left and high platforms 34 on the right.

The automatic driving system of the train consists T, after having taken over the control of the train consist T itself, and having acquired the orientation thereof by means of special sensors, routs it and places it on the correct stabling track BIN1 or BIN2.

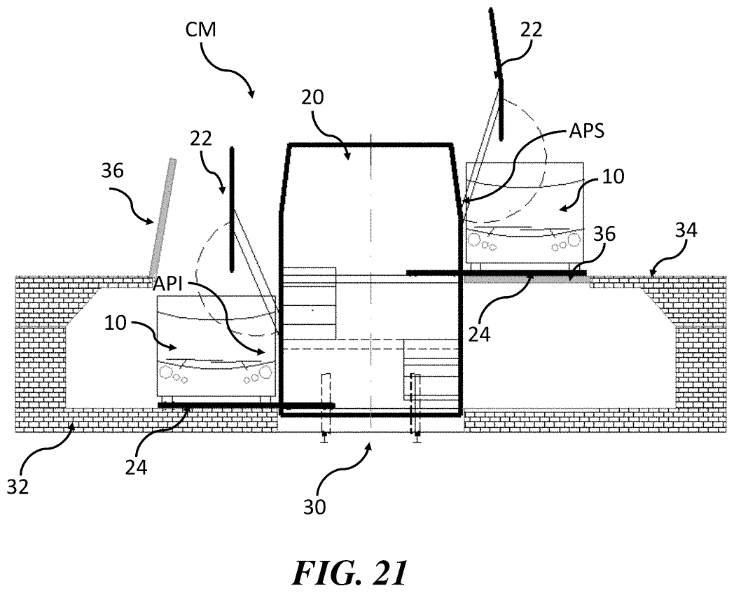

With reference to the embodiment shown in FIG. 21, it is possible to provide for the use of two-story platforms, for example a low one 32 on the right of the railway module 20 and a high one 34 on the left of the railway module 20 which make the orientation with which the train consist T is positioned on the stabling tracks not significant.

The high platforms 34 have a movable portion 36, movable between a lowered position and a raised position, to allow, when not in use, the opening of the doors 22 of the lower floor of the railway module 20. The automatic driving system of the train consists T provides for the correct positioning and consistent handling of the movable platforms 36.

Distributed intelligence systems and appropriate networks of actuators and sensors may be provided for the control of the routes and the automatic driving of the trains T.

Distributed intelligence systems and appropriate networks of actuators and sensors may be provided for controlling the automatic driving of the road modules 10 and the movement of all the mechanisms involved in the operations for loading and unloading the road modules 10. For example, such mechanisms may be:
the sliding platforms 24 of the railway modules 20,
the doors 22 of the railway modules 20, and
the movable platforms 36 of the platform for accessing the upper floors of the railway modules 20, whatever the orientation of the train consist T is.

The systems of sensors and actuators present inside the railway modules 20 and the road modules 10 may be connected to a fiber or wireless network (IoT).

The intangible infrastructural component SW supporting the system CM will now be described.

A movable high-performance data network (throughput, data rate, handover, latency) may be provided, also with real-time ground-train functions.

Data analytics functions and algorithms may be provided to transform the raw data collected by the network, from all the sensors connected, into operational information for diagnostic and machine-learning purposes.

Booking, ticketing, and tracking applications are provided to manage and offer customized flexibility options to the customer, made possible by the system CM, and to make operational choices in real time.

In the stations S1 . . . S11 Vehicle to Infrastructure systems (V2I) and Infrastructure to Vehicle systems (I2V) may be provided for the automatic driving of the road modules 10 within the areas of the stations or interchange stop points.

Computer systems and machine-learning algorithms may be provided for running the operating system and taking real-time decisions (artificial intelligence).

The systems described in the prior art mainly concern urban-suburban mobility.

The system CM for the integrated medium-long distance road-rail mobility of the present invention, instead, describes the management of a national and international medium-long distance mobility system.

The system CM described in the present invention is based on the following procedures, operating systems and business models with the aim of always putting the traveler and the traveling good at the center of the system CM and of the service offered.

The operations for booking and collecting the vehicle 10, selecting the travel segment and the type of configuration and paying are managed by means of a dedicated application on the personal devices of travelling customers.

The procedures for boarding and unboarding the road modules 10 inside the hubs S1 . . . S11 are controlled by smart systems which reside in the infrastructure of the hub itself. Such systems are based on automatic control techniques which guide the movement of both railway 20 and road 10 modules.

The driving and handling of the road modules 10 and of the railway modules 20 therefore occur automatically without any intervention by the passengers of the road module 10 and the driving staff of the trains T.

Such automatic driving modes are activated for the road modules 10 when passing through the gate of the hub S1 . . . S11 and for the railway modules 20 when entering the area controlled by the safety and signaling systems of the dedicated hub.

The operating systems which manage the fleet of road modules 10, making them available in the hubs and rental stations according to real-time demand, are run by artificial intelligence computer systems by means of machine-learning algorithms.

The operating systems which manage the fleet of railway modules 20, making them available in the hubs according to demand and in accordance with the timetables assigned by the Railway Infrastructure Manager of the relevant Country, are run by artificial intelligence computer systems by means of machine-learning algorithms. Such systems which manage the fleet of railway modules 20 must be connected to the smart railway traffic planning systems of the Infrastructure Manager itself.

To optimize infrastructure capacity, the trains T may be equipped with virtual coupling systems, which allow two trains to run at a very short distance from each other so that they may both use the same train slot but then take different routes while running, without having to stop for release and coupling operations.

The trains T may therefore travel virtually coupled to one another or to trains of another type or of other railway operators.

The users to whom this solution is suggested belong to a social segment which is sensitive to the values of environmental sustainability and fight against climate change and are therefore looking for mobility models based on electrified systems and equipped with maximum energy efficiency.

The system CM combines the extensiveness of the road mode with the energy efficiency of the railway mode: the use, where possible, of the railway mode, in fact, involves a specific energy consumption (per load unit) which is significantly lower than that of the road mode.

The suggested invention also achieves, for most journeys, a significant reduction in travel time by being able to develop commercial speeds on railway mode which are at least double with respect to the road mode alone.

The strong search for safety (reduction of accidents), currently only obtainable with automated and digitized systems based on a guided and highly controlled driving technology such as the railway, also makes it preferable to use it on the travel segments where an adequate railway infrastructure exists.

Another relevant aspect in this sense—security—is linked to the possibility of quickly carrying out security checks when the road module 10 passes through the station gates: such checks do not generate any inconvenience for passengers and ensure the protection of drivers, passengers, modules and goods thereof during the trip.

The systems which allow passive millimeter medium wave (PMMW) checks, adapted to detect the presence of undeclared passengers and objects and substances considered dangerous, may in fact be available at the interchange terminals.

The system CM also allows the use thereof by people with reduced mobility (PRM): such subjects, often penalized in tourism or work journeys, by virtue of the system CM, may travel in a manner in all respects identical to any other user. No architectural barriers are present and, furthermore, the user does not depend in any way on the availability of specialized operators or other forms of assistance.

The monitoring systems integrated into the tangible components of the system CM and connected to the network (IoT) are capable of detecting information, generating raw data, and transmitting them in real time. Such data refer to users, to the railway module 20, to the road module 10 and to the infrastructure 30, and allow a single managing entity of the system CM to have a complete and exhaustive vision aimed at improving the quality of the service and at optimizing the maintenance operations with the purpose of predicting relevant events.

Obviously, without prejudice to the principle of the invention, the construction details and embodiments may vary widely with respect to the description disclosed merely by way of example, without departing from the scope of the present invention.

1) Integrated mobility system (CM) comprising:
at least one road module (10),
at least one railway module (20), adapted to contain a plurality of road modules (10) therein, and
a plurality of loading and unloading infrastructures (30, 31, 32, 34, 36) arranged in a plurality of boarding and unboarding stations (S1, S2, S3, S4, S5, S6, S7, S8, S9, S10, S11) scattered over the territory to allow the operations for boarding and unboarding the road modules (10) from the railway module (20), wherein said railway module (20) is a two-story high-speed railway module (20), wherein said boarding and unboarding stations (S1, S2, S3, S4, S5, S6, S7, S8, S9, S10, S11) are equipped with said loading and unloading infrastructures (30, 31, 32, 34, 36) arranged so that said operations for boarding and unboarding the road module (10) with respect to said railway module (20) are always possible regardless of the position occupied by the road module (10) inside the railway module (20) and regardless of the simultaneous boarding and unboarding of other road modules (10), and
wherein said road module (10) and said railway module (20) are arranged to be automatically interconnected to each other in the condition in which said road module (10) is received inside said railway module (20).

2) The integrated mobility system (CM) according to claim 1, wherein said road module (10) comprises rechargeable batteries (15), wherein said railway module (20) includes a traction system comprising rechargeable batteries (25), and wherein the physical and functional interconnection between the road module (10) and the railway module (20) allows the connection (26) of the rechargeable batteries (15) of the road module (10) to the rechargeable batteries (25) of the railway module (20).

3) The integrated mobility system (CM) according to claim 2, wherein the physical and functional interconnection between the road module (10) and the railway module (20) allows:
the connection (28) of the air-conditioning system of the road module (10) to the air-conditioning system of the railway module (20), and
the mechanical connection and the fastening between the road module (10) and the railway module (20).

4) The integrated mobility system (CM) according to claim 3, wherein said railway module (20) is equipped with movable systems (22, 24) adapted to cooperate with said loading and unloading infrastructures (30, 31, 32, 34, 36) to perform said operations for boarding and unboarding the road module (10) from the railway module (20).

5) The integrated mobility system (CM) according to claim 4, wherein the movement of movable systems (22, 24) for loading and unloading the road modules (10) with respect to the railway modules (20) is performed with manual systems, or with hydraulic systems or electrical systems, which involve the use of slides, rolling bearings or magnetic bearings.

6) The integrated mobility system (CM) according to claim 5, wherein said movable systems (22, 24) comprise doors (22) for closing and opening the compartments of the railway module (20) and sliding platforms (24) to allow said operations for boarding and unboarding the road module (10).

7) The integrated mobility system (CM) according to claim 6, wherein said movable systems (22, 24) are selected from:
ejecting and upward sliding closing and opening doors (22);
closing and opening doors (22) made in an appropriate number of segments of the retractable roller shutter type which will roll up until concealing in the ceiling of the compartment of the railway module (20),
closing and opening winged doors (22) hinged on the upper side, and
closing and opening winged doors (22) hinged on the lower side.

8) The integrated mobility system (CM) according to claim 7, wherein said loading and unloading infrastructures (30, 31, 32, 34, 36) arranged in the boarding and unboarding stations (S1, S2, S3, S4, S5, S6, S7, S8, S9, S10, S11) comprise the construction of tracks equipped with platforms (30,31,32,34) for the access to the two boarding levels of the two-story railway module (20), and wherein said loading and unloading infrastructures (30, 31, 32, 34, 36) comprise at least one access platform to the lower floor (32) and at least one access platform to the upper floor (34).

9) The integrated mobility system (CM) according to claim 8, wherein said loading and unloading infrastructures (30, 31, 32, 34, 36) comprise two access ramps (31) to the lower platform (32) and to the upper platform (34).

10) The integrated mobility system (CM) according to claim 9, wherein said access platform to the upper floor (34) comprises a movable portion (36), movable between a lowered position and a raised position, to allow, when not in use, the opening of the doors (22) of the lower floor of the railway module (20).

11) The integrated mobility system (CM) according to claim 10, wherein said road module (10) is designed as a standard car with a propulsion system chosen from: conventional, hybrid, plug-in hybrid, full electric battery powered or fuel cell powered.

12) The integrated mobility system (CM) according to claim 11, wherein, in the road modules (10) with plug-in hybrid or electric battery powered propulsion system, the connection (26), which may be wireless or by means of the connectors of the rechargeable batteries (15) of the road module (10), to the rechargeable batteries (25) of the railway module (20) occurs in parallel.

13) The integrated mobility system (CM) according to claim 12, wherein at least one railway module (20) is equipped with a compartment for road modules adapted to transport people with reduced mobility.

14) The integrated mobility system (CM) according to claim 13, wherein railway modules (20) are provided in which the bogies are shared with the adjacent railway modules (20).

15) A road module (10) adapted to be used in the integrated mobility system (CM) according to one or more of claims 1 to 14, wherein said road module (10) takes on a housing function in the railway mode and becomes a true car in the road mode.

16) The road module (10) according to claim 15, wherein said road module (10) is equipped with sliding doors to optimize the space when it is inside the railway module (20).

17) The road module (10) according to claim 16, wherein said road module (10) is equipped with a “concealable” steering wheel.

18) The road module (10) according to claim 17, wherein said road module (10) is equipped with manual or automatic systems for rotating the front seats (A1, B1, C1) to allow the occupants to travel vis-a-vis with the rear seat occupants (D1, E1, F1) in the railway mode, while maintaining a conventional driving position in the road mode.

19) The road module (10) according to claim 18, wherein said road module (10) is equipped with mechanical slides for sliding the front seats (A1, B1, C1) wherein said mechanical slides are controlled manually or in an automatic and synchronized manner.

20) The road module (10) according to claim 19, wherein said road module (10) is equipped with broadband wireless data connection and VOIP voice connection systems, satellite navigation, multimedia entertainment, travel information and ticketing.

21) A railway module (20) adapted to be used in the integrated mobility system (CM) according to one or more of claims 1 to 14, wherein the railway module (20) provides for the boarding of the road modules (10) at two different levels (32, 34) on the same side or on opposite sides.

22) The railway module (20) according to claim 21, comprising sensors and actuators connected in fiber or wireless network.

23) A train (T) consisting of a plurality of railway modules (20) according to claim 21 or claim 22.

24) Loading and unloading infrastructures (30, 31, 32, 34, 36) adapted to be used in the integrated mobility system (CM) according to one or more of claims 1 to 14, wherein stabling tracks are provided, comprising sets of platforms (32a, 34a, 32b, 34b) to obtain stabling tracks of a double length with respect to the length of the train (T) consisting of a plurality of railway modules (20) and wherein a first portion of the set of platforms (32a, 34a, 32b, 34b) includes high platforms (30a) facing the right side of the train (T) consisting of a plurality of railway modules (20) and low platforms (34a) facing the left side of the train (T) consisting of a plurality of railway modules (20) and wherein a second portion of the set of platforms (32a, 34a, 32b, 34b) includes high platforms (34b) facing the left side of the train (T) consisting of a plurality of railway modules (20) and low platforms (32b) facing the right side of the train (T) consisting of a plurality of railway modules (20).

25) The loading and unloading infrastructures (30, 31, 32, 34, 36) according to claim 24, wherein said loading and unloading infrastructures (30, 31, 32, 34, 36) comprise a plurality of stabling tracks (BIN1, BIN2) of a length equal to that of a train (T) consisting of a plurality of railway modules (20), a part (BIN1) of which is equipped with low platforms (32) on the right and high platforms (34) on the left and the remaining (BIN2) with low platforms (30) on the left and high platforms (34) on the right.

26) The loading and unloading infrastructures (30, 31, 32, 34, 36) according to claim 25, wherein an automatic driving system is present for routing the train (T), consisting of a plurality of railway modules (20), and for placing it on the correct stabling track (BIN1, BIN2).

27) A method for managing an integrated mobility system (CM) comprising the steps of:
arranging at least one road module (10),
arranging at least one railway module (20), adapted to contain a plurality of road modules (10) therein, and
arranging a plurality of loading and unloading infrastructures (30, 31, 32, 34, 36) arranged in a plurality of boarding and unboarding stations (S1, S2, S3, S4, S5, S6, S7, S8, S9, S10, S11) scattered over the territory to allow the operations for boarding and unboarding the road modules (10) from the railway module (20), wherein said railway module (20) is a two-story high-speed railway module (20),
wherein said method includes the step of equipping said boarding and unboarding stations (S1, S2, S3, S4, S5, S6, S7, S8, S9, S10, S11) with said loading and unloading infrastructures (30, 31, 32, 34, 36) arranged so that said operations for boarding and unboarding the road module (10) with respect to said railway module (20) are always possible regardless of the position occupied by the road module (10) inside the railway module (20) and regardless of the simultaneous boarding and unboarding of other road modules (10), and
wherein said method includes the step of arranging said road module (10) and said railway module (20) so as to be automatically interconnected to each other in the condition in which said road module (10) is received inside said railway module (20).
